(19) United States
(12) Patent Application Publication
(10) Pub. No.: US 2014/0124125 A1
(43) Pub. Date: May 8, 2014

(54) METHOD AND APPARATUS FOR CONTROLLING WELDING OF FLEXIBLE FABRICS

(71) Applicant: MILLER WELDMASTER CORPORATION, Navarre, OH (US)

(72) Inventors: Brent Gene Nussbaum, Dalton, OH (US); Timothy M. Hupp, SR., Navarre, OH (US)

(73) Assignee: MILLER WELDMASTER CORPORATION, Navarre, OH (US)

(21) Appl. No.: 13/828,658

(22) Filed: Mar. 14, 2013

Related U.S. Application Data
(60) Provisional application No. 61/722,483, filed on Nov. 5, 2012.

(51) Int. Cl. B29C 65/00; B65H 21/00

(52) U.S. Cl. CPC B29C 66/912; B65H 21/00
USPC 156/157; 156/359

(57) ABSTRACT

A machine and method for welding first and second fabric panels together. The machine includes a welding head which travels along a frame, applying heat and pressure to an overlapped region of the panels. An infrared camera is positioned to monitor the seam temperature after formation. The camera takes a thermal image across the width of the seam and transmits the data to a central processing unit (CPU). Programming in the CPU compares the thermal image data with a pre-programmed ideal temperature profile. Based on the comparison, the CPU makes adjustments to one or more of the speed of travel of the welding head, and the heat and pressure applied by the welding head, if necessary. The CPU activates an alarm to alert the machine operator if the adjustments aren't successful. The machine further includes a marking assembly for identifying regions on the welded seam which may require post-production testing.

### CROSS-REFERENCE TO RELATED APPLICATIONS

This application claims the benefit of U.S. Provisional Patent Application Ser. No. 61/722,483, filed Nov. 5, 2012, the entire specification of which is incorporated herein by reference.

### BACKGROUND OF THE INVENTION

1. Technical Field

This invention relates generally to flexible fabrics. More particularly, this invention relates to a method and apparatus for joining two panels of flexible fabric together. Specifically, this invention is directed to a method and apparatus for monitoring the integrity of seam formation during heat-welding of panels of flexible fabric which includes using an infrared camera to measure the temperature of the seam substantially immediately after formation of the same.

2. Background Information

Heat welding has long been used to join waterproof sheet materials together to manufacture a variety of products such as tents, tarpaulins, liners for pools and landfills, awnings, military products and others. During the manufacturing process, two or more panels of flexible industrial fabric or technical textile, such as vinyl, are joined together into a single sheet. This is accomplished by overlapping sections of the panels of fabric and then applying heat and pressure to the overlapped sections to weld the materials together and form a seam. This procedure permits longer panels of the sheet materials to be produced so that the desired end product may be fabricated out of the same.

Various techniques have been developed to join sheet materials of this nature together. These include hot air welding, hot wedge welding and impulse welding. In hot air welding a nozzle is positioned so as to blow heated air between the two layers of sheet material. Typically, for a thermoplastic sheet material, the temperatures involved range anywhere from 200 F to 1,350 F (90 C to 750 C). Once the heat has been introduced between the layers, a roller passes over the same, applying a preset level of pressure to the layers. The combination of the heat and pressure joins the two panels of sheet materials together. Hot air welding requires precise temperatures and pressure to be applied to the sheet materials and also requires that the process be done in a timely fashion in order to prevent cooling of the sheet materials before the roller passes over the same.

Hot wedge welding is fairly similar to hot air welding, with the exception that instead of a nozzle being used to introduce heat into the system, a heated wedge is used. The wedge is positioned so that the fabric layers are pulled over the wedge immediately before they are contacted by the rollers. Wedges are typically heated to a temperature of between 200 F and 920 F (90 C and 490 C). Once again, the temperature, pressure and time have to be closely monitored in order to create a good seam.

Some of the problems surrounding welding of a first and a second fabric panel together by any of the above methods are the need to apply heat and pressure in a consistent manner to the overlapped regions of the fabric panels and the need to keep the panels immobilized during the application of heat and pressure. If either of the panels move, or if the heat or pressure are not applied in a consistent fashion, the quality of the seam so produced will suffer. Ideally, as the seam is formed, sufficient heat and pressure is applied progressively along the entire length of the overlapped sections to bond the panels of fabric together. Occasionally, the temperature of the applied heat may drop below optimum levels because of temperature fluctuations in the heated air or the wedge which is being used to heat the overlapped regions. The applied heat may be sufficient to temporarily stick the panels together but may not be sufficient to permanently bond the panels together by way of a heat-welded seam. Additionally, imperfections in the fabric or the way the fabric panels are overlapped may force the rollers of the welding machine temporarily away from the fabric in an area immediately adjacent the imperfection. This movement will decrease the amount of pressure applied in that adjacent area and will result in a seam that is not necessarily strong enough to withstand the stresses and strains that will be required of the finally fabricated product. Again, the issues caused by the decreased application of pressure may not be immediately visible to the eye. If for the reasons described above, the seam is not welded properly along its entire length, the bond between the fabrics in certain regions of the seam may fail prematurely.

It is difficult for a manufacturer to tell if welded seams have met the integrity demands of the finished product. There is therefore a need in the art for a method and apparatus for monitoring seam welding that will address some or all of the abovementioned issues.

### SUMMARY

The device comprises a machine for welding a first and second fabric panel together which enables a manufacturer to better evaluate the integrity of the seams welded by the machine. The machine includes a frame and a welding head mounted for travel at a first speed along a portion of the frame. The welding head is configured to apply heat and pressure to overlapped edges of the first and second fabric panels to form a seam. The machine further includes an infrared camera mounted on one of the frame and the welding head and positioned to monitor a temperature in the seam. In particular, the infrared camera monitors the temperature in the seam shortly after passage of the welding head thereover. The infrared camera takes a thermal image across the width of the seam and transmits the data so gathered to a central processing unit (CPU) which is preferably provided on the machine. Programming in the CPU compares the data from the thermal image with a preprogrammed ideal temperature and then, based on the comparison, makes adjustments to one or more of the speed of travel of the welding head, and the heat and pressure applied by the welding head, if necessary. If the adjustments prove insufficient to overcome deficiencies in the seam integrity, the CPU activates an alarm to alert the machine operator. The machine further includes a marking assembly for identifying regions on the welded seam which may require post-production testing.

There is further disclosed herein a method of welding a first flexible fabric to a second flexible fabric includes the steps of:
placing an edge of the first fabric over an edge of the second fabric to form an overlapped region;
applying heat and pressure to the overlapped region to weld the overlapped region into a seam;
measuring a temperature of the seam; and
computing whether the temperature of the seam falls within a desired range of temperatures.

Furthermore, the step of measuring the temperature of the seam is performed by taking a thermal image of the seam using an infrared camera.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a side elevational view of a welding machine in accordance with the present invention;

FIG. 2 is a partial top view of the vacuum track of the welding machine showing a portion of a nozzle applying heat to the overlapped region of the first and second fabrics, the roller, and the infrared camera (in phantom) monitoring the welding zone on the seam being formed;

FIG. 3 is a partial cross-sectional front view of the vacuum track showing the seam between the first and second fabrics being monitored by the infrared camera; and

FIG. 4 is a flow-chart illustrating the method for monitoring the quality of the weld formed by the welding machine when joining two flexible fabrics.

Similar numbers refer to similar parts throughout the drawings.

### DETAILED DESCRIPTION

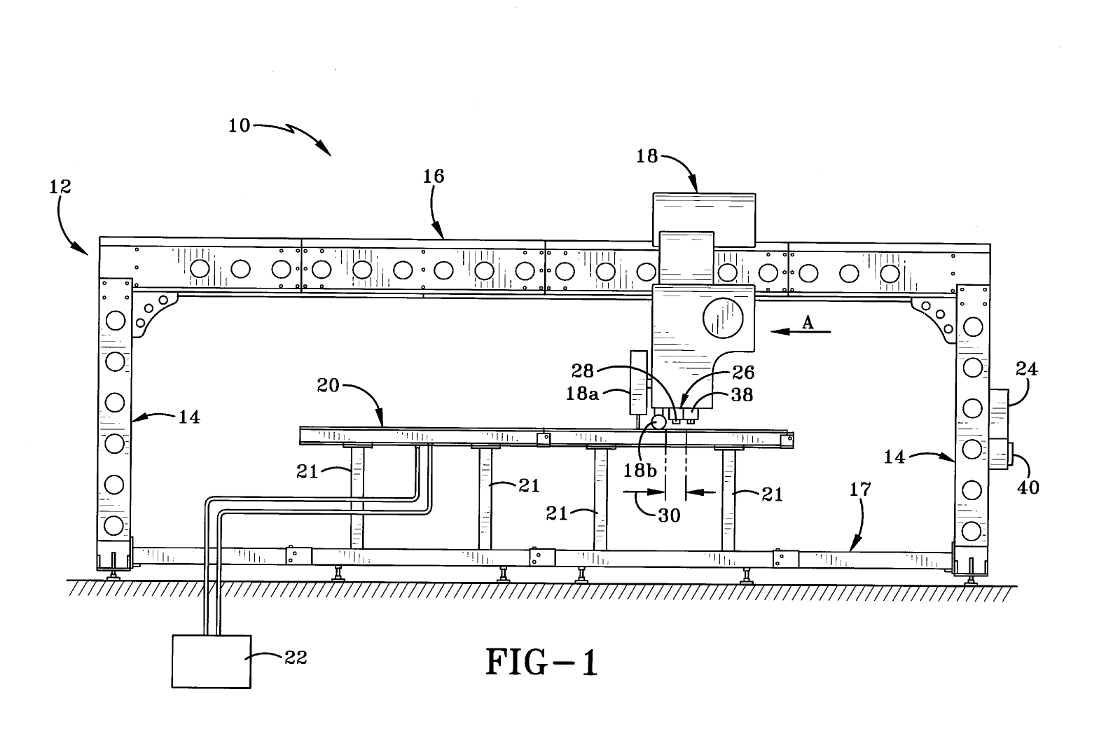

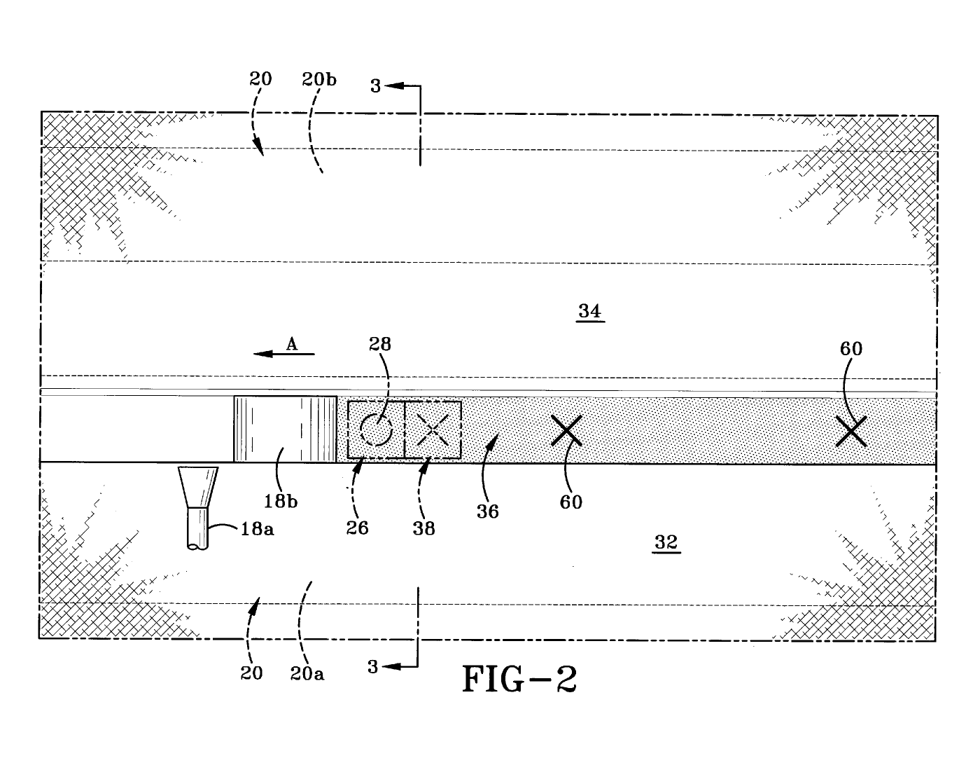

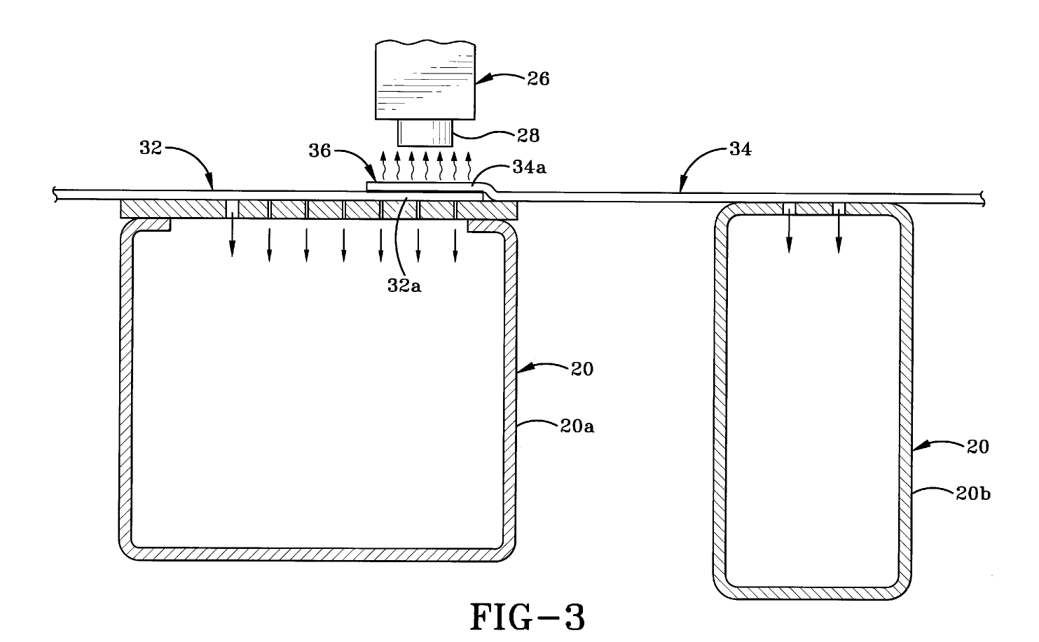

Referring to FIGS. 1-3, there is shown an exemplary apparatus for welding two partially overlapped panels or sheets of industrial or technical fabric together. (The fabric panels are not shown in FIG. 1 but are shown as first fabric 32 and second fabric 34 in FIGS. 2 and 3). The apparatus comprises a welding machine 10 having a frame 12 which includes end supports 14 spanned by a top beam 16 and a bottom beam 17. A welding head 18 is engaged on for travel along beam 16. Welding head 18 includes a first assembly 18a for applying heat to the overlap of the fabrics and a second assembly 18b for applying pressure thereto. First assembly 18a, as illustrated herein, is a nozzle from which hot air is directed between the overlapped fabrics to be welded. Second assembly 18b, as illustrated herein, is a roller which applies pressure to the regions of the fabrics heated by the blast of hot air from first assembly 18a.

Welding machine 10 further includes a vacuum track assembly comprising a vacuum track 20 and a vacuum source 22. Vacuum track 20, comprising first and second track sections 20a, 20b, is mounted on legs 21 and is disposed vertically beneath top beam 16. Welding head 18 extends downwardly from beam 16 toward track 20, and is positioned to apply heat and pressure to overlapped regions 32a, 34a (FIG. 3) of the first and a second fabrics 32, 34 supported on the upper surfaces of the first and second track sections 20a, 20b. In particular, the first and second track sections 20a, 20b have perforated upper surfaces upon which the fabrics 32, 34 are placed. Vacuum source 22 evacuates air from the interior of track sections 20a, 20b and thereby retains the fabrics 32, 34 on the associated upper surface by suction. This arrangement effectively reduces the chances of the fabrics shifting when engaged by welding head 18.

It should be understood that the configuration of the welding machine 10 shown in the attached figures is by way of example only and any other suitable configurations may be utilized.

In accordance with a specific feature of machine 10 and its method of use, welding machine 10 further includes a central processing unit (CPU) 24 for controlling the operation of machine 10. CPU 24 is operatively connected to welding head 18 and includes programming which controls the speed of movement of welding head 18 along top beam 16, as well as the application of heat and pressure by first and second assemblies 18a, 18b of welding head 18 to fabrics 32, 34 positioned on vacuum track 20. CPU 24 also controls vacuum source 22 and therefore the production of a vacuum in vacuum track 20 to retain the fabrics 32, 34 thereto.

In accordance with yet another specific feature of machine 10 and its method of use, welding machine 10 further includes a camera assembly 26 mounted at any suitable location on welding machine 10, such as on frame 12 or even on vacuum track 20. Preferably, camera assembly 26 is mounted on welding head 18. Camera assembly 26 includes a focal plane array (FPA), uncooled, microbolometer infrared camera 28. This type of camera is preferred because the microbolometer detectors utilized in the camera are relatively maintenance free. Infrared camera 28 includes a plurality of microbolometer sensors (not shown) which detect infrared radiation with wavelengths of about 7.5-14 μm emanating from the seam 26 in zone 30. The infrared radiation (FIG. 3) strikes detector material in the microbolometer sensors in camera 28 and heats the same. As the detector material is heated, its electrical resistance is changed and the change is measured and converted into temperatures which are processed to generate an image. These types of sensors do not need to be cooled. Thus, infrared thermal imaging camera 28 is able to detect the actual gathered temperature of the seam 36 a pre-determined distance after it has been formed.

Infrared camera 28 is operatively connected to CPU 24 which further includes programming to control the operation thereof. When camera 28 generates a thermal image of seam 36, it transmits this data to CPU 24. The data is transmitted wirelessly or through wires (not shown) connecting welding head 18 to CPU 24.

Camera 28 preferably is mounted on welding head 18 rearwardly of the roller 18b and is directed to focus on a region of vacuum track 20. As welding head 18 moves along top beam 16, so does camera 28 and thus the region of vacuum track 20 upon which camera 28 focusses progressively changes. This changing region of focus is identified herein as the zone 30 which is located a fixed distance rearwardly of roller 18b. Thus, zone 30 moves progressively along vacuum track 20 with the moving welding head 18. Camera 28 is configured to focus on both a width “W” and a length “L” of zone 30 and to measure the temperature across the same. Utilizing the programming of CPU 24, the size of zone, particularly the width “W” thereof, may be changed to be complementary to the width of the seam that is to be formed between two panels of fabric 32, 34.

FIG. 2 shows a top view of the first panel of fabric 32 and the second panel of fabric 34 which are placed in partially overlapping arrangement on vacuum track 20 of welding machine 10. In particular, a first edge region 34a of second fabric 34 overlaps a first edge region 32a of first fabric 32 as is shown in FIG. 3. Initially, the overlapped regions 32a, 34a are separate and unbounded. The overlapped regions 32a, 34a only become bonded or welded together when welding head 18 passes thereover, and applies both heat and pressure thereto. The specific quantity of heat and specific amount of pressure to be applied to the overlapped regions 32a, 34a are programmed into CPU 24. As welding head 18 moves progressively from one end of the vacuum track 20 to the other, the heat and pressure applied thereby welds the overlapped regions 32a, 34a together to form a seam 36.

In accordance with a specific feature of machine 10 and its method of use, as the seam 36 forms, camera 28 is activated by CPU 24 to monitor the temperature of the formed seam 36. Specifically, camera 28 monitors the temperature across the entire width “W” of the seam 36 by generating a thermal image of the seam 36 in the zone 30 and then feeding the data gathered therefrom to the CPU 24. As welding head 18 moves continuously in the direction of arrow “A” (FIG. 1), the zone 30 also moves in the direction of arrow “A” and camera 28 continuously creates a thermal image of the formed seam 36 in zone 30 and feeds that information to the CPU 24. The operation of the welding machine utilizing camera 28 to monitor the quality of the seam 36 will be further described herein.

In accordance with yet another specific feature of machine 10 and its method of use, welding machine 10 further includes a marking assembly 38. Preferably, marking assembly 38 is located on welding head 18 and is operatively connected to CPU 34. Marking assembly 38 may be any suitable device or mechanism which is utilized to apply a marking or tag to one or more of the first and second fabrics 32, 34 or to the seam 36 upon activation of assembly 38 by CPU 24. Specifically, marking assembly 38 is configured and positioned to apply the marking or tag to first or second fabrics 32, 34, or to the seam 36 when instructed to do so by CPU 24. This marking occurs to typically identify specific regions of the seam that are questionable and which therefore require post-production testing for strength and integrity. Marking assembly 38 may, for example, comprise a marking implement mounted on a movable arm which is able to be moved downwardly toward seam 36 or toward first or second fabrics 32, 34. Marking assembly 38 places a quantity of ink or dye onto the surface of one or more of the seam, the first fabric and the second fabric. The marking 60 is made in a region that aligns with the region where the thermal image generated by camera 28 does not fall within the desired temperature range programmed into CPU 24.

Alternatively, marking assembly 38 may include a movable arm which is moved to adhere a sticker, a tag, or an electronic tracking device, such as an RFID tag, to one or more of the upper surface of the first or second fabrics 32, 34 or the seam 36. Any suitable marking will suffice. While marking assembly 38 is typically employed to identify possible weak regions of seam 36, randomized regions for post-production testing can be marked thereby for quality testing purposes, even when camera 28 has not detected any particular issues with seam 36. Such randomized marking can be programmed into CPU 24.

In accordance with yet another specific feature of machine 10 and its method of use, welding machine 10 further includes an alarm 40 which is operatively connected to CPU 24. Alarm 40 may be mounted on any part of the frame 12, welding head 18, track 20, or camera 28. Alarm 40 is activated by CPU 24 to alert an operator to a problem with the welding operation. The alarm will be activated if refining adjustments cannot be made to the welding head 18 by the CPU to correct inconsistencies in the welds. Alarm 40 may take any one of a number of suitable forms, such as components for generating lights or sounds, computer images, electronic signals etc. The alarm may therefore be a visible or audible warning or may be in the form of a text message or page to an operator's phone, for example. Preferably, alarm 40 is also operatively linked to a shut-off mechanism on machine 10. If alarm 40 is activated, the machine 10 may automatically shut down until the operator takes necessary action to correct the problem and then resets the machine 10.

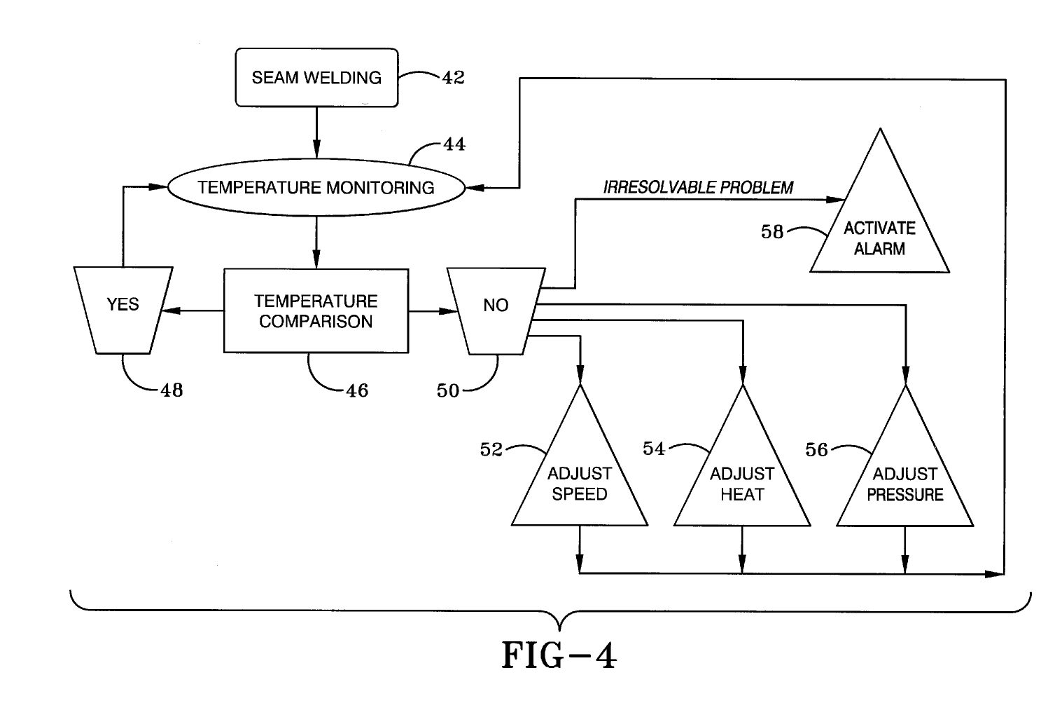

FIG. 4 shows a flow chart illustrating the method of monitoring seam formation using a welding machine 10 which includes an infrared camera. Box 42 indicates that welding of the seam 36 commences. Box 44 indicates that camera 28 takes a temperature reading of seam 36 in zone 30. The gathered temperature data is fed to CPU 24. Programming in CPU 24 compares the gathered temperature data to an ideal pre-programmed seam temperature. This step is indicated by box 46. If the gathered temperature is in the ideal seam temperature range programmed into CPU 24, signified by the “Yes” box 48, a signal is sent by the CPU 24 to welding head 18 to continue to maintain its speed along top beam 16, and to maintain the degree of heat and pressure it is applying to the overlapped regions 32a, 34a. The CPU 24 also signals camera 28 to continue taking temperature readings as welding head 18 travels along top beam 16.

If, however, the CPU comparison determines that the gathered temperature is not in the ideal temperature range, signified by the “No” box 50 in FIG. 4, then the CPU 24 sends a signal to the welding head 18 to change one or more of the speed of travel along top beam 16 (box 52), the heat applied to the overlapped fabric regions 32a, 34a (box 54), and the pressure applied to the overlapped fabric regions 32a, 34a (box 56). The CPU 24 also signals marking assembly 38 to apply marking 60 (FIG. 2) to identify that portion of seam 36 which had insufficient pressure or heat applied thereto to bond seam 36 to the desired degree. The marking 60 is illustrated herein as the character “X” but it will be understood that any type of marking can be applied to one of seam 36, first fabric 32 and second fabric 34. The CPU further signals the camera 28 to continue gathering temperatures (box 44) and the process of comparing the gathered and ideal temperatures and making necessary speed, heat and temperature adjustments is continued. If after one, two or more cycles the CPU 24 programming continues to conclude that adjustments cannot be readily made to create a properly welded seam, a signal is sent from the CPU 24 to alarm 40 to alert the operator and/or switch off machine 10. This is indicated by the activate alarm box 58 in FIG. 4. At this point, adjustments may have to be made by the operator to reset the parameters of welding head 18 and then restart the welding process. Once welding of the seam 36 is completed, the integrity of the regions of seam 36 marked by tags 56 may be readily tested to determine if the seam 36 meets the desired standards.

CPU 24 is thus provided with programming including logic which sets out the welding parameters for welding the fabric seam 36. The data gathered by camera assembly 26 provides real time closed loop data back to the welding parameters in CPU 24. The logic enables CPU 24 to make adjustments in the speed, heat and pressure applied by welding head 18 in response to the gathered data to ensure consistently welded seams are produced. It should be noted that therefore the above-described system and method is configured to continuously and consistently measure the integrity of seam 36 in real time and to make real time on-the-spot adjustments to the welding process as needed. Additionally, this system may be utilized in any type of fabric welding machines, including conventional and automated systems that require non-contact imaging and temperature measurements.

Additionally, it will be understood that camera 28 may be used to target multiple zones 30 on seams 36 and provide multiple alarms 40 and marking assemblies 38, each of which is associated with one of those multiple target zones. CPU 24 may be programmed to cover a wide temperature range for calibration to any types of fabrics. The present system also provides plug-and-play compatibility with a wide range of welding machines 10. It will further be understood that CPU may also be of a type that is able to store and back-check data and to retain real type analog and MPEG-4 digital video output for storage and back checking.

It is also possible for the operator to be in a remote location and be connected to CPU to monitor the system. Preferably, CPU is provided on welding machine 10 as described herein and thus machine 10 is a stand-alone unit. However, in some instances, the CPU may be provided on a portable PC device to transport to multiple locations to monitor temperature on a variety of different welding machines 10.

It will be understood that while the preferred embodiment camera 28 described herein is a focal plane array, uncooled microbolometer infrared camera, other types of cooled or uncooled infrared cameras may be utilized for the purpose described herein.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. A machine for welding a first fabric panel and a second fabric panel together comprising:
a frame;
a welding head mounted for travel at a speed along a portion of the frame, said welding head being adapted to apply heat and pressure to overlapped edges of the first and second fabric panels to form a seam; and
an infrared camera mounted on one of the frame and the welding head and adapted to monitor a temperature in the seam.

2. The machine as defined in claim 1, wherein the infrared camera includes uncooled microbolometer sensors.

3. The machine as defined in claim 1, further comprising:
a central processing unit mounted on the frame and operatively engaged with the welding head and the infrared camera;
programming provided in the central processing unit to control one or more of the speed of travel of the welding head, the heat applied by the welding head, and the pressure applied by the welding head in response to data gathered by the infrared camera.

4. The machine as defined in claim 1, further including a marking assembly adapted to place a mark on one of the seam, the first fabric and the second fabric.

5. The machine as defined in claim 3, further including an alarm operatively connected to the central processing unit.

6. A method of welding a first flexible fabric to a second flexible fabric comprising the steps of:
placing an edge of the first fabric over an edge of the second fabric to form an overlapped region;
applying heat and pressure to the overlapped region to weld the overlapped region into a seam;
measuring a temperature of the seam; and
computing whether the temperature of the seam falls within a desired range of temperatures.

7. The method as defined in claim 6, wherein the step of applying heat and pressure is accomplished by moving a welding head at a speed along the length of the overlapped region.

8. The method as defined in claim 6, wherein the step of measuring the temperature of the seam is performed by taking a thermal image of the seam using an infrared camera.

9. The method as defined in claim 8, wherein the step of taking a thermal image further includes taking a thermal image across the entire width of the seam.

10. The method as defined in claim 9, wherein the step of taking a thermal image of the seam includes generating a thermal image across a width of the seam.

11. The method as defined in claim 7, further comprising the steps of:
continuing to apply the same speed of travel of a welding head, and the same level of heat and the same level of pressure to the overlapped edges of the first and second fabrics in response to the measured temperature falling within the desired range of temperatures.

12. The method as defined in claim 6, further comprising the step of:
measuring the temperature in a zone of the seam substantially immediately after applying heat and pressure to weld the overlapped edges of the first and second fabrics together.

13. The method as defined in claim 7, further comprising the step of:
adjusting the level of one or more of the speed of travel of the welding head, the application of heat and the application of pressure to the overlapped edges of the first and second fabrics in response to the measured temperature not falling within the desired range of temperatures.

14. The method as defined in claim 13, further comprising the steps of:
making additional adjustments to the one or more of the speed of travel of the welding head, the heat applied thereby and the pressure applied thereby if a successive measured temperature continues not to fall within the desired range of temperature.

15. The method as defined in claim 14, further comprising the step of:
activating an alarm in response to continued failure of the measured temperature to fall within the desired range of temperature.

16. The method as defined in claim 15, further comprising the step of stopping the welding of the first and second fabric after activation of the alarm.

17. The method as defined in claim 13, further comprising the step of:
applying a marking to one or more of the seam, the first fabric and the second fabric in response to the failure of the measured temperature falling within the desired range of temperature.

18. The method as defined in claim 17, wherein the step of applying the marking includes applying the marking at a position on the one or more of the seam, the first fabric and the second fabric which corresponds to a region in which a generated thermal image indicates that the measured temperature of the same does not match the desired range of temperature.

19. The method as defined in claim 17, wherein the step of applying the marking comprises applying a dye, an ink, a sticker, a tag or an electronic tracking device to the one or more of the seam, the first fabric and the second fabric.

20. The method as defined in claim 7, further comprising the step of:
maintaining the adjusted level of one or both of heat and pressure if the temperature measured after making the adjustments falls within the desired range of temperatures.

21. The method as defined in claim 4, further comprising the steps of:
applying a mark to a region of the seam in response to the measured temperature in that region of the seam not falling within the desired range of temperatures.

22. The method as defined in claim 10, further comprising the step of sounding an alarm in response to the measured temperatures in successive regions of the seam not falling within the desired range of temperatures.

23. The method as defined in claim 11, further comprising the step of shutting down the machine after sounding of the alarm.
